(19) United States
(12) Patent Application Publication
(10) Pub. No.: US 2009/0247224 A1
(43) Pub. Date: Oct. 1, 2009

(54) Pluggable Input Device for Chiral Customization of a Mobile Phone

(76) Inventor: John D. Postoyko, Hemel Hempstead (GB)

Correspondence Address: Dillon & Yudell LLP, 8911 N. Capital of Texas Hwy, Suite 2110, Austin, TX, 78759, US

(21) Appl. No.: 12/059,740

(22) Filed: Mar. 31, 2008

(51) Int. Cl. H04M 1/02

(52) U.S. Cl. 455/557

(57) ABSTRACT

A method of attaching a removable user interface (UI) input device to a mobile phone in a handedness-neutral manner is presented. The method includes incorporating a left-side module socket and a right-side module socket into a mobile phone, such that the left-side module socket is oriented on a left side of the mobile phone, the right-side module socket is oriented on a right side of the mobile phone, and the left-side module socket and the right-side module socket are each capable of electrically and physically coupling with a removable user interface (UI) input device. The UI input device is then selectively coupled to the left-side module socket or the right-side module socket according to a left or right handedness of a user of the mobile phone.

### BACKGROUND OF THE INVENTION

1. Technical Field

The present disclosure relates in general to the field of communication devices, and more particularly to cellular phones. Still more particularly, the present disclosure relates to input devices for cellular phones.

2. Description of the Related Art

Cellular phones typically have a main input device section on the face of the cellular phone. This main input device section includes a keypad, up/down scroll buttons, etc. Such input and navigation control may be augmented by a device on a side of the telephone, such as a tracking ball, scroll wheel, joystick, etc. Since the vast majority of users will be right-handed, manufacturers affix such “side” devices on the right side of the cellular phone. This makes the use of such phones problematic for left-handed users, since the cell phone is not chiral (left-handed or right-handed) customizable for the side devices.

### SUMMARY OF THE INVENTION

A method of attaching a removable user interface (UI) input device to a mobile phone in a handedness-neutral manner is presented. The method includes incorporating a left-side module socket and a right-side module socket into a mobile phone, such that the left-side module socket is oriented on a left side of the mobile phone, the right-side module socket is oriented on a right side of the mobile phone, and the left-side module socket and the right-side module socket are each capable of electrically and physically coupling with a removable user interface (UI) input device. The UI input device is then selectively coupled to the left-side module socket or the right-side module socket according to a left or right handedness of a user of the mobile phone.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 illustrates an exemplary cellular phone in which the present invention may be utilized;

FIG. 2 depicts a front view of a cellular phone having left and right input device interfaces;

FIG. 3 illustrates a right and left side view of the cellular phone shown in FIG. 2; and

FIG. 4 is a high-level flow-chart of steps taken to customize a cell phone according to the left-or-right-handedness (chirality) of the user.

### DETAILED DESCRIPTION OF THE PREFERRED EMBODIMENT

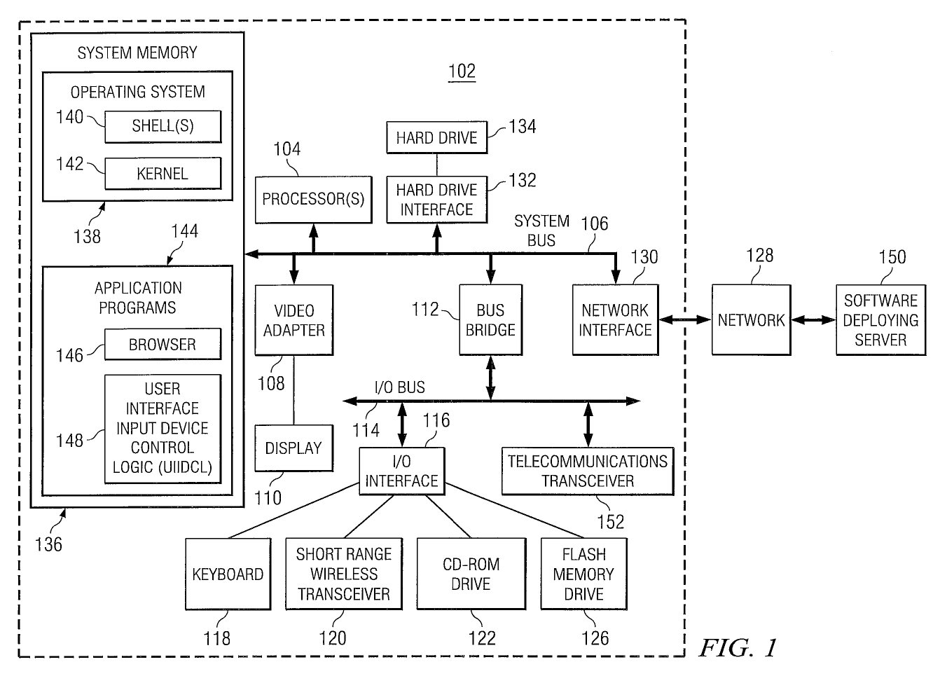

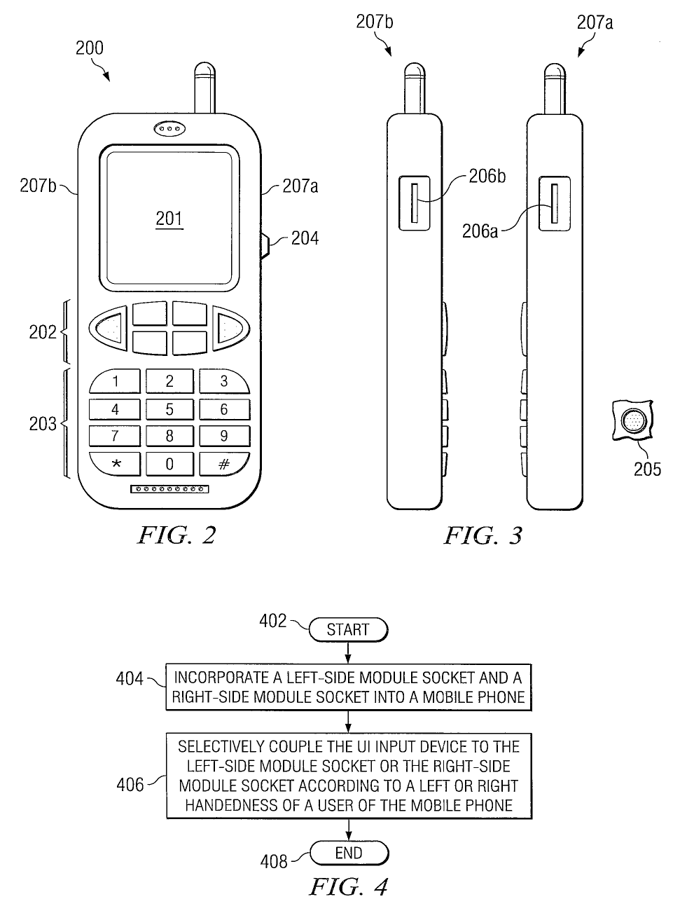

With reference now to FIG. 1, there is depicted a block diagram of an exemplary computer 102 in which the present invention may be implemented. Some or all of the architecture shown for computer 102 may be utilized by server 150 and/or cellular phone 200 (shown below in FIG. 2). Computer 102 includes one or more processors 104 that are coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a Short Range Wireless Transceiver 120, a Compact Disk—Read Only Memory (CD-ROM) drive 122, and a flash drive memory 126. Keyboard 118 may be a standard keyboard (e.g., QWERTY style or similar), or a condensed alphanumeric keypad. The format of the ports connected to I/O interface 116 may be any known to those skilled in the art of computer architecture, including but not limited to Universal Serial Bus (USB) ports. Short Range Wireless Transceiver 120 utilizes short range wireless electromagnetic signals (e.g. wireless spread spectrum, radio frequency (RF), infrared (IR)) to allow Computer 102 to transmit or receive voice or data with a similarly configured telecommunication device. A telecommunications transceiver 152 allows the computer 102 (e.g., a cellular phone 200 as shown in FIG. 2) to wirelessly communicate with a cellular network (e.g., network 128).

Computer 102 is able to communicate with a software deploying server 150 via a network 128 using a network interface 130, which is coupled to system bus 106. Network interface 130 may utilize wired or wireless technology such as a cellular broadcast to connect with Network 128. Network 128 may be an external network such as the Internet, an internal network such as an Ethernet or a Virtual Private Network (VPN), and/or a wireless cellular telephone network. Note again the software deploying server 150 may utilize a same or substantially similar architecture as computer 102.

A hard drive interface 132 is also coupled to system bus 106. Hard drive interface 132 interfaces with a hard drive 134. In a preferred embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (also called a command processor) is generally the highest level of the operating system software hierarchy and serves as a command interpreter. The shell provides a system prompt, interprets commands entered by keyboard or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a browser 146. Browser 146 includes program modules and instructions enabling a World Wide Web (WWW) client (i.e., computer 102) to send and receive network messages to the Internet using HyperText Transfer Protocol (HTTP) messaging, thus enabling communication with software deploying server 150.

Application programs 144 in system memory 136 (as well as software of deploying server 150 system memory) also include a User Interface Input Device Control Logic (UIIDCL) 148. UIIDCL 148 includes code for implementing the processes described in FIGS. 2-4, including, but not limited to, adjusting a Graphical User Interface (GUI) display according to whether an attachable user interface input device is plugged into a right or left side of the cellular phone. In one embodiment, computer 102 is able to download UIIDCL 148 from software deploying server 150, including in an “on demand” basis. Note further that, in one embodiment of the present invention, software deploying server 150 performs all of the functions associated with the present invention (including execution of UIIDCL 148), thus freeing computer 102 from having to use its own internal computing resources to execute UIIDCL 148.

The hardware elements depicted in computer 102 are not intended to be exhaustive, but rather are representative to highlight essential components required by the present invention. For instance, computer 102 may include alternate memory storage devices such as magnetic cassettes, Digital Versatile Disks (DVDs), Bernoulli cartridges, and the like. These and other variations are intended to be within the spirit and scope of the present invention.

With reference now to FIG. 2, a depiction of a cellular phone 200, enabled with the novel features described herein, is presented. Cellular phone 200 has a screen 201, which is a Graphical User Interface (GUI) that provides information to a user, including information downloaded from wireless sources such as a Wireless Application Protocol (WAP) enabled phone for accessing the Internet. General navigation and call control keys 202 and alphanumeric pad 203 allow the user to make and receive phone calls. User Interface (UI) input device 204 is specially adapted for navigating around the GUI, including navigating through webpages, spreadsheets, etc. Note that cellular phone 200 has a right side 207a and a left side 207b.

As depicted in FIG. 3, the right side 207a has a right-side UI input device module socket 206a, while the left side 207b has a left-side UI input device module socket 206b. Each of the UI input device module sockets 206a-b are coupled to logic (e.g., I/O interface 116 and UIIDCL 148 shown in FIG. 1) within the cellular phone 200 that enables the cellular phone 200 to “understand” the chirality (left or right-handedness) of the UI input device 205 that will be plugged into either of the UI input device module sockets 206a-b. That is, a same UI input device 205 may be plugged into either of the UI input device module sockets 206a-b. Logic internal to the cellular phone 200 will “flip” the input according to which of the UI input device module sockets 206a-b is used. Thus, if the UI input device 205 is a scroll wheel that was originally designed to be plugged into the right-side UI input device module socket 206a, then the internal logic will “reverse” the inputs from the scroll wheel when the UI input device 205 is plugged into the left-side UI input device module socket 206b, such that scrolling “up” is the same whether the scroll wheel is plugged into the left or right UI input device module socket 206a-b.

Referring now to FIG. 4, a high-level flow chart of exemplary steps taken to attach a removable user interface (UI) input device to a mobile phone in a handedness-neutral manner. After initiator block 402, a left-side module socket and a right-side module socket are incorporated into a mobile phone (block 404). The left-side module socket is oriented on a left side of the mobile phone, the right-side module socket is oriented on a right side of the mobile phone, and the left-side module socket and the right-side module socket are each capable of electrically and physically coupling with a removable user interface (UI) input device. Note that the UI input device may be, but is not limited to being, a tracking ball, a scroll wheel, a joystick, etc. As described in block 406, the UI input device is selectively coupled to either the left-side module socket or the right-side module socket according to a left or right handedness of a user of the mobile phone. The process ends at terminator block 408.

While the present invention has been particularly shown and described with reference to a preferred embodiment, it will be understood by those skilled in the art that various changes in form and detail may be made therein without departing from the spirit and scope of the invention. For example, while the present description has been directed to a preferred embodiment in which custom software applications are developed, the invention disclosed herein is equally applicable to the development and modification of application software. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A method of attaching a removable user interface (UI) input device to a mobile phone in a handedness-neutral manner, the method comprising:
incorporating a left-side module socket and a right-side module socket into a mobile phone, wherein the left-side module socket is oriented on a left side of the mobile phone, wherein the right-side module socket is oriented on a right side of the mobile phone, and wherein the left-side module socket and the right-side module socket are each capable of electrically and physically coupling with a removable user interface (UI) input device; and
selectively coupling the UI input device to the left-side module socket or the right-side module socket according to a left or right handedness of a user of the mobile phone.

2. The method of claim 1, wherein the removable UI input device is a tracking ball.
